(19) United States
(12) Patent Application Publication
(10) Pub. No.: US 2022/0123378 A1
(43) Pub. Date: Apr. 21, 2022

(54) LINEAR CHARGER WITH HIGH RDSON TRANSISTOR AND ASSOCIATED CHARGE METHOD

(71) Applicant: Chengdu Monolithic Power Systems Co., Ltd., Chengdu (CN)

(72) Inventor: Haigang Cao, Hangzhou (CN)

(21) Appl. No.: 17/488,595

(22) Filed: Sep. 29, 2021

(30) Foreign Application Priority Data
Oct. 21, 2020 (CN) 202011136631.8

(51) Int. Cl. H01M 10/44; H02J 7/00

(52) U.S. Cl. CPC H01M 10/446; H02J 7/00036; H02J 7/007182

(57) ABSTRACT

A linear charger for providing a system voltage to a load and providing a charge current to charge a battery. The linear charger has a first transistor and second transistor. The first transistor has a first terminal to receive an input voltage and a second terminal coupled to the load. The second transistor is connected between the second terminal of the first transistor and the battery. The second transistor operates in a pre-charge mode at a first charge stage, in a constant current charge mode at a second charge stage, in a current reduction mode at a third charge stage, and in a constant voltage charge mode at a fourth charge stage.

### CROSS-REFERENCE TO RELATED APPLICATION(S)

This application claims the benefit of CN application No. 202011136631.8 filed on Oct. 21, 2020 and incorporated herein by reference.

### TECHNICAL FIELD

This disclosure relates generally to electrical circuit, and more particularly but not exclusively relates to a linear charger with increased Rdson transistor and associated charge method.

### BACKGROUND

As battery-powered devices become more compact and have more power-consuming features, the space left for batteries becomes more and more limited. In addition, most batteries are not removable, so the long working hours and working efficiency of battery-powered devices, has become a top priority. To improve the portability and make the device wearable, higher battery-capacity auxiliary charging devices are used in such as mobile power for smartphones, charging cases for earbuds and e-cigarettes.

Due to increased demand for portable device performance and conflicts between battery size and capacity, auxiliary charging devices require a more compact design (smaller size) and higher efficiency (longer working hours), and other devices such as charging cases have the same requirements.

### SUMMARY

In accomplishing the above and other objects, there has been provided a charge method for a linear charger in accordance with an embodiment of the present invention. The linear charger has a first transistor coupled between an input node and a system node and a second transistor coupled between the system node and a battery, receives an input voltage and provides a system voltage for a load and a charge current to charge the battery. The charge method comprises: at a first charge stage, pre-charging the battery with a first value of the charge current until the battery voltage increases to a first threshold voltage; at a second charge stage, charging the battery with a second value of the charge current, wherein the battery voltage continues to increase, and wherein the first value is less than the second value; at a third charge stage, the charge current decreases from the second value to a third value and the battery voltage is increased to a second threshold voltage, wherein the third value is higher than a first value; and at a fourth charge stage, decreasing the charge current to a fourth value and keeping the battery voltage at the second threshold voltage.

There has been provided a linear charger for providing a system voltage to a load and providing a charge current to charge a battery in accordance with an embodiment of the present invention. The linear charger has a first transistor and second transistor. The first transistor has a first terminal to receive an input voltage and a second terminal coupled to the load. The second transistor is coupled between the second terminal of the first transistor and the rechargeable battery. The second transistor is configured to operate in a pre-charge mode at a first charge stage, operate in a constant current charge mode at a second charge stage, operate in a current reduction mode at a third charge stage, and operate in a constant voltage charge mode at a fourth charge stage.

There has been provided a charge method for providing a system voltage to a load and providing a charge current to charge a battery, in accordance with an embodiment of the present invention. The charge method comprises: at a first charge stage, pre-charging the battery with a first value of the charge current until the battery voltage is increased to a first threshold voltage; at a second charge stage, charging the battery with a second value of the charge current for continuing to increase the battery voltage, wherein the second value is higher than the first value; at a third charge stage, the charge current decreases from second value until the battery voltage is increased to a second threshold; and at a fourth charge stage, decreasing the charge current to a fourth value and keeping the battery voltage at the second threshold voltage.

### BRIEF DESCRIPTION OF THE DRAWINGS

The following detailed description of various embodiments of the present invention can best be understood when read in conjunction with the following drawings, in which the features are not necessarily drawn to scale but rather are drawn as to best illustrate the pertinent features.

FIG. 1 illustrates a linear charger 100 with integrated power path management.

FIG. 2 illustrates current and voltage waveforms during a prior charging process of a battery.

FIG. 3 illustrates a linear charger 100a with integrated power path management according to an embodiment of the present invention.

FIG. 4 illustrates current and voltage waveforms during a charging process of a battery according to an embodiment of the present invention.

FIG. 5 illustrates a flow chart of a charge method 300 for a linear charger according to one embodiment of the present invention.

### DETAILED DESCRIPTION

Various embodiments of the present invention will now be described. In the following description, some specific details, such as example circuits and example values for these circuit components, are included to provide a thorough understanding of the embodiments. One skilled in the relevant art will recognize, however, that the present invention can be practiced without one or more specific details, or with other methods, components, materials, etc. In other instances, well-known structures, materials, processes or operations are not shown or described in detail to avoid obscuring aspects of the present invention.

Throughout the specification and claims, the term “coupled,” as used herein, is defined as directly or indirectly connected in an electrical or non-electrical manner. The terms “a,” “an,” and “the” include plural reference, and the term “in” includes “in” and “on”. The phrase “in one embodiment,” as used herein does not necessarily refer to the same embodiment, although it may. The term “or” is an inclusive “or” operator, and is equivalent to the term “and/or” herein, unless the context clearly dictates otherwise. The term “based on” is not exclusive and allows for being based on additional factors not described, unless the context clearly dictates otherwise. The term “circuit” means at least either a single component or a multiplicity of components, either active and/or passive, that are coupled together to provide a desired function. The term “signal” means at least one current, voltage, charge, temperature, data, or other signal. Where either a field effect transistor (“FET”) or a bipolar junction transistor (“BJT”) may be employed as an embodiment of a transistor, the scope of the words “gate”, “drain”, and “source” includes “base”, “collector”, and “emitter”, respectively, and vice versa. Those skilled in the art should understand that the meanings of the terms identified above do not necessarily limit the terms, but merely provide illustrative examples for the terms.

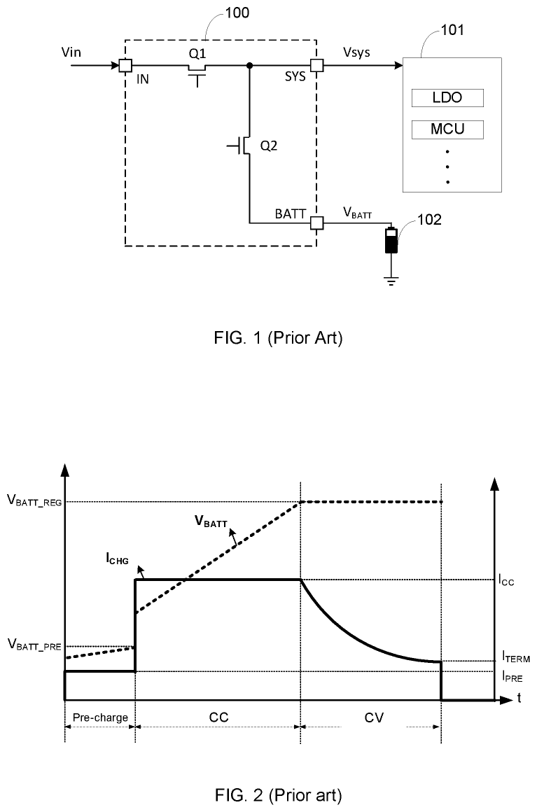

The battery-powered device used in the earbud charging box includes a linear charger with integrated power path management. FIG. 1 illustrates a linear charger 100 with integrated power path management. As shown in FIG. 1, the linear charger 100 obtains power from an AC adapter or a USB interface, supplies power to a system load 101, and charges a re-chargeable battery 102 at the same time. The system load 101 comprises an electrical equipment such as LDO or MCU.

The power path management is used to automatically select an input power source, a battery, or both to provide continuous power supply to the system load 101. As shown in FIG. 1, the linear charger 100 comprises a first transistor Q1 coupled between an input node IN and a system node SYS, and a second transistor Q2 coupled between the system node SYS and a battery node BATT. In the example of FIG. 1, the on-resistance of the first transistor Q1 is 300 mΩ, and the on-resistance of the second transistor Q2 is 100 mΩ.

In a tradition application, the input node IN of the linear charger 100 is coupled to the USB interface to receive an input voltage Vin of 5V, a system voltage Vsys at the system node SYS is regulated to be 4.65V for supplying the system load 101, and the battery voltage V_{BATT} is kept at 4.4V after the battery is fully charged. A charge profile in the tradition application includes three charge stages: a pre-charge charge stage, a constant current (CC) charge stage and a constant voltage (CV) charge stage, as shown in FIG. 2.

FIG. 2 illustrates current and voltage waveforms during a prior charging process of a battery.

As shown in FIG. 2, at the pre-charge stage, the fully-discharged battery is pre-charged at a small current I_{PRE} and the battery voltage V_{BATT} increases to a first threshold voltage V_{BAT_PRE} before entering the CC charge stage.

At the CC charge stage, the battery is charged quickly at a constant charge current I_{CHG} that equals to a current reference I_{CC}, the battery voltage V_{BATT} increases to a second threshold voltage V_{BAT_REG} before entering the CV charge stage.

At the CV charge stage, the charge current I_{CHG} is decreased gradually and the battery voltage V_{BATT} is kept at the second threshold voltage V_{BATT_REG} until the charge current I_{CHG} is decreased to reach the current threshold I_{TERM} which is called termination current. The CV charge stage ends, the battery is nearly full, and the charging process is complete.

According to the above prior charge process, both the first transistors Q1 and the second transistor Q2 operate in its saturation region at the three charge stages discussed above.

As the development of technology and applications, in order to improve the efficiency of the linear charger 100 shown in FIG. 1, it is desired to further reduce the input voltage Vin at the input node IN, for example, reducing the input voltage Vin from 5V to 4.6V, while still regulating the system voltage Vsys at a regulation value (e.g., 4.65V), and keeping the fully-charged battery voltage V_{BATT} at 4.4V.

For the linear charger 100 shown in FIG. 1, it is generally believed that the smaller the on-resistance of the first transistor Q1, the smaller the conduction loss in the current path, and thus the higher the efficiency of the linear charger 100. This is to say, a solution to reduce on-resistance of the first transistor Q1 is easy to come up with and usually used in the applications.

However, if the solution to reduce the on-resistance of the first transistor Q1 is used, there are some deficiencies including the following: the size of the first transistor Q1 increases, and the overall size of the linear charger 100 (i.e., integrated chip) increase. In addition, the input quiescent current becomes higher and the manufacture cost also become higher.

As discussed in more detail below, the present invention has recognized that increasing on-resistance of the first transistor Q1 shown in FIG. 1, for example, by 3 times to 5 times, which will make the linear charger 100 more efficient and have better overall performance. In other words, the solution of increasing the on-resistance of the first transistor Q1 can produce unexpected technical effect which is surprisingly better than the solution reducing the on-resistance of the first transistor Q1.

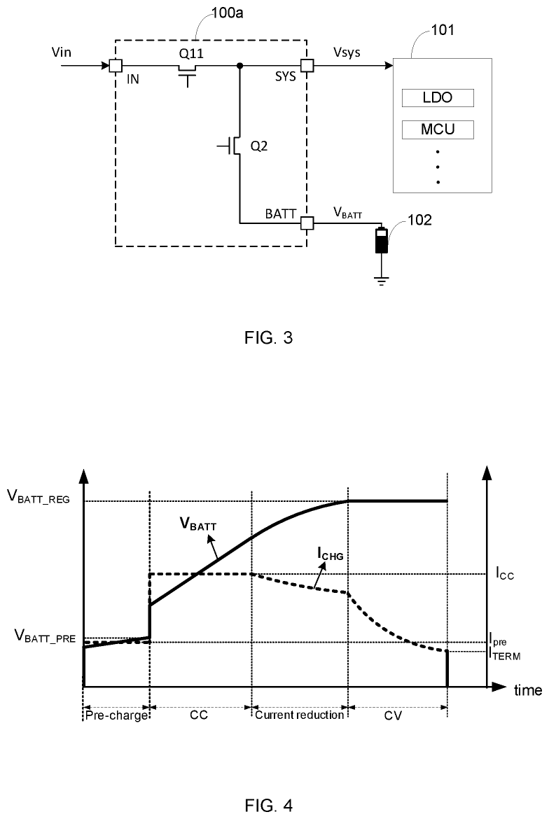

FIG. 3 illustrates a linear charger 100a with integrated power path management according to an embodiment of the present invention. As shown in FIG. 3, the linear charger 100a still can adopt the circuit structure shown in FIG. 1. The linear charger 100 comprises a first transistor Q11 coupled between an input node IN and a system node SYS, and a second transistor Q2 coupled between the system node SYS and a battery node BATT. The on-resistance of the transistor Q11 is different to that of the transistor Q1 shown in FIG. 1. In one embodiment, a difference is that the on-resistance of the transistor Q11 shown in FIG. 3 is at least three times that of the transistor Q1 shown in FIG. 1. In the example of FIG. 3, the on-resistance of the first transistor Q11 is 1Ω, and the on-resistance of the second transistor Q2 is 100 mΩ.

Compared to the traditional solution shown in FIG. 1, in the embodiment of FIG. 3, the input voltage Vin is reduced from original 5V to 4.6V, and the on-resistance of the first transistor Q11 coupled between the input node IN and the system node SYS is increased to, e.g. 1Ω. And most importantly, at the same time, the second transistor Q2 is configured to operate in a pre-charge mode at a first charge stage, operate in a CC charge mode at a second charge stage, operate in a current reduction mode at a third charge stage and in a CV charge mode at a fourth charge stage. This battery charge process is shown in FIG. 4.

In one embodiment, the on-resistance of the first transistor Q11 is ten times the on-resistance of the second transistor Q2, for example, the on-resistance of the first transistor Q11 is 1Ω, the on-resistance of the second transistor Q2 is 100 mΩ.

FIG. 4 illustrates current and voltage waveforms during a charging process of a battery according to an embodiment of the present invention. In the example shown in FIG. 4, the battery charge process includes the first charge stage to a fourth charge stage.

At the first charge stage, i.e. the pre-charge stage, the fully discharged battery 102 is pre-charged with a small current I_{PRE} as the charge current I_{CHG} and the system voltage Vsys increases to a first threshold voltage V_{BAT_PRE} before entering the second charge stage.

At the second charge stage, i.e. the CC charge stage, the battery 102 is charged quickly at the constant charge current I_{CHG} that equals to a current reference I_{CC}, the battery voltage V_{BATT} continues to increase. The second transistor Q2 operate in regulation mode (i.e., the saturation and light linear region) at the second charge stage.

Subsequently, at the third charge stage, due to the increasing on-resistance of the first transistor Q11, the charge current I_{CHG} is gradually and automatically decreased, for example, from the current reference I_{CC} to be a smaller value, the battery voltage V_{BATT} continues to increase to the second threshold voltage V_{BAT_REG} before entering the fourth charge stage. The second transistor Q2 operate in fully on mode (i.e., ohmic region) during the third CV charge stage. It should be noted that the linear charger 100a and the second transistor Q2 enters the third charge stage naturally and no trigger conditions are required.

At the fourth charge stage, i.e., the CV charge stage, the charge current I_{CHG} is decreased gradually and the battery voltage V_{BATT} is kept at the second threshold voltage V_{BATT}_REG until the charge current I_{CHG} is decreased to reach the current threshold I_{TERM}. The CV charge stage ends, the battery 102 is nearly full.

In the above first to fourth charge stage shown in FIG. 4, the first transistor Q11 shown in FIG. 3 always operates in ohmic region. And the second transistor Q2 operates in ohmic region at the third charge region. In one embodiment, the input voltage Vin is not higher than the regulated system voltage Vsys. In a further embodiment, the input voltage Vin is limited to be 4.6V, the system voltage Vsys is regulated to be 4.65V, the battery voltage V_{BATT} is kept at 4.4V after the battery is fully charged.

In one embodiment, the first transistor Q11 and the second transistor Q2 shown in FIG. 3 are FETs. The Rdson of the first FEF transistor Q11 become higher for the sake of small size and improved efficiency. In one embodiment, the first transistor Q11 is increased from previous 300 mΩ to 1Ω of the present invention, which significantly reduce the die size of the product in some applications, for example, TWS application including the charger in earbud and charging case.

The ohmic region of the FET transistor (also called the linear region) is the region where the drain current, ID, has a linear response to changes in the drain-source voltage, VDS, which mimics the linear response that would be obtained from Ohm's Law. And the Ohmic Region is the only region on a FET transistor Characteristics curve where there is a linear response in current from changes in the voltage.

By comparing with the tradition charge profile shown in FIG. 2, under the condition that the same battery 102 is charged from fully-discharged to fully-charged, the battery 102 absorbs the same energy from the input. While increasing on-resistance of the first transistor Q11 can reduce the die size of the first transistor Q11 and the corresponding driving current, which also decreases the whole size of the linear charger 100a and improve the charging efficiency.

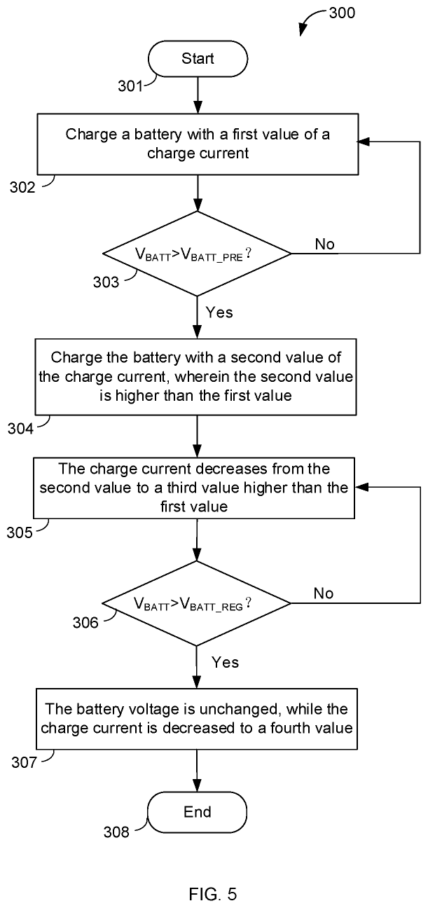

FIG. 5 illustrates a flow chart of a charge method 300 for a linear charger according to one embodiment of the present invention. The linear charger comprises a first transistor coupled between an input node and a system node, and a second transistor coupled between the system node and the battery. The linear charger receives an input voltage and provides a system voltage for a load, and charges to a battery with a charge current. The charge method comprises step 301˜308.

At step 301, the linear charger starts to operate and enters into a first charge stage of the battery charge process.

At step 302, the battery is pre-charged with a first value of the charge current and the battery voltage increases.

At step 303, the battery voltage increase to a first threshold voltage V_{BATT_PRE} before entering the next step 304. Wherein the steps 302 and 303 form the first charge stage, pre-charge stage.

At step 304, the battery is charged with a second value of the charge current, the battery voltage continues to increase, wherein the first value is less than the second value. The step 304 is a second charge stage of the battery charge process, is the constant current charge stage.

At step 305, the charge current starts to decrease from the second value, the battery voltage continues to increase. in one embodiment, the charge current decreases from the second value to a third value, and the third value is higher than the first value.

At step 306, the battery voltage increased to a second threshold voltage before entering stage 307. Steps 305 and 306 construct a third charge stage, i.e., the current reduction charge stage.

At step 307, the charge current continues to decrease until reaching the termination current I_{TERM}, the battery voltage is kept at a second threshold voltage. The charge current is decreased to a fourth value before entering the step 308.

At step 308, the battery charge process ends.

In one embodiment, the first transistor operates in ohmic region at the first charge stage to the fourth charge stage. The second transistor is configured to operate in ohmic region at the third charge stage.

In another embodiment, a charge method for providing a charge current to a rechargeable battery is used. The charge method comprises: at a first charge stage, pre-charging the battery with a first value of the charge current until the battery voltage is increased to a first threshold voltage; at a second charge stage, charging the battery with a second value of the charge current to increase the battery voltage, wherein the second value is higher than the first value; at a third charge stage, decreasing the charge current from second value until the battery voltage is increased to a second threshold voltage; and at a fourth charge stage, decreasing the charge current to a fourth value and keeping the battery voltage at the second threshold voltage. In one embodiment, a second transistor coupled a terminal of the battery operates in ohmic region at the third charge stage.

In the embodiments of the present invention, the difference between the input voltage and the system voltage is decreased, the charge process to the battery is expanded to be the pre-charge charge stage, the constant current charge stage, the current reduction charge stage and the constant voltage charge stage. Wherein at the current reduction charge stage, the charge current flowing into the battery decreases, and the battery voltage continues to increase until the battery voltage reaches the second threshold voltage before entering the constant voltage charge stage. It not only improves the charging curve, but also reduces the quiescent current, achieving a more compact design and lower BOM cost, with outstanding efficiency performance.

In this document, relational terms such as first and second, and the like may be used solely to distinguish one entity or action from another entity or action without necessarily requiring or implying any actual such relationship or order between such entities or actions. Numerical ordinals such as “first,” “second,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A charge method for a linear charger, the linear charger has a first transistor coupled between an input node and a system node and a second transistor coupled between the system node and a battery, receives an input voltage and provides a system voltage for a load and a charge current to charge the battery, the charge method comprising:
at a first charge stage, pre-charging the battery with a first value of the charge current until the battery voltage increases to a first threshold voltage;
at a second charge stage, charging the battery with a second value of the charge current, wherein the battery voltage continues to increase, and wherein the first value is less than the second value;
at a third charge stage, the charge current decreases from the second value to a third value and the battery voltage is increased to a second threshold voltage, wherein the third value is higher than a first value; and
at a fourth charge stage, decreasing the charge current to a fourth value and keeping the battery voltage at the second threshold voltage.

2. The charge method of claim 1, wherein the first transistor operates in ohmic region at the first to fourth charge stage.

3. The charge method of claim 1, wherein the second transistor operates in ohmic region at the third charge stage.

4. The charge method of claim 1, wherein the input voltage is not higher than the system voltage.

5. The charge method of claim 1, wherein the difference between the system voltage and the battery voltage at the third charge stage is lower than the difference between the system voltage and the battery voltage at the second charge stage.

6. The charge method of claim 1, wherein the on-resistance of the first transistor is at least three times greater than the on-resistance of the second transistor.

7. The charge method of claim 6, wherein the on-resistance of the first transistor is ten times the on-resistance of the second transistor.

8. A linear charger for providing a system voltage to a load and providing a charge current to charge a rechargeable battery, comprising:
a first transistor having a first terminal to receive an input voltage and a second terminal coupled to the load; and
a second transistor coupled between the second terminal of the first transistor and the rechargeable battery, wherein the second transistor is configured to operate in a pre-charge mode at a first charge stage, operate in a constant current charge mode at a second charge stage, operate in a current reduction mode at a third charge stage, and operate in a constant voltage charge mode at a fourth charge stage.

9. The linear charger of claim 8, wherein the first transistor operates in ohmic region at the first to fourth charge stage.

10. The linear charger of claim 8, wherein the second transistor operates in ohmic region at the third charge stage.

11. The linear charger of claim 8, wherein the input voltage is not higher than the system voltage.

12. The linear charger of claim 8, wherein at the third charge stage, the charge current decreases, and the battery voltage increases to a second threshold voltage before entering the fourth charge stage.

13. The linear charger of claim 8, wherein the on-resistance of the first transistor is at least three times greater than the on-resistance of the second transistor.

14. A charge method for providing a system voltage to a load and providing a charge current to a rechargeable battery, comprising:
at a first charge stage, pre-charging the battery with a first value of the charge current until the battery voltage is increased to a first threshold voltage;
at a second charge stage, charging the battery with a second value of the charge current for continuing to increase the battery voltage, wherein the second value is higher than the first value;
at a third charge stage, the charge current decreases from second value until the battery voltage is increased to a second threshold voltage; and
at a fourth charge stage, decreasing the charge current to a fourth value and keeping the battery voltage at the second threshold voltage.

15. The charge method of claim 14, wherein a first transistor is coupled between an input node and a system node and is configured to operate in ohmic region at the first to fourth charge stage.

16. The charge method of claim 15, wherein an input voltage at the input node is not higher than the system voltage.

17. The charge method of claim 15, wherein a second transistor is coupled between the system node and the battery and is configured to operate in ohmic region at the third charge stage.

18. The charge method of claim 17, wherein the second transistor enters the third charge stage without any sensing.

19. The charge method of claim 17, wherein the on-resistance of the first transistor is at least three times greater than the on-resistance of the second transistor.

20. The charge method of claim 17, wherein a voltage across the second transistor at the third charge stage is lower than the voltage across the second transistor at the second charge stage.
